(19) United States
(12) Patent Application Publication
(10) Pub. No.: US 2017/0296851 A1
(43) Pub. Date: Oct. 19, 2017

(54) Fire Fighting Sprinkler Device Having Leveling Correcting Function

(71) Applicant: PROTECTOR SAFETY IND., LTD., TAOYUAN COUNTY (TW)

(72) Inventor: Jung-Wen Chen, Taoyuan County (TW)

(21) Appl. No.: 15/132,791

(22) Filed: Apr. 19, 2016

(51) Int. Cl. A62C 35/68; G01C 9/02; B05B 15/08

(52) U.S. Cl. CPC A62C 35/68; B05B 15/08; G01C 9/02

(57) ABSTRACT

A fire fighting sprinkler device having a leveling, correcting function includes a sprinkling head body at different locations of which a plurality of outlets having different spraying directions are disposed, the outlets being fluidly connected to each other by means of the sprinkling head body, the sprinkling head body being fluidly connected to a fire water supply pipeline by using a pipe joint, the pipe joint having at least one rotary connecting center line; and a level-meter fixed to the sprinkling head body and having a horizon reference surface, wherein the level-meter is disposed along a radial slit of the rotary connecting center line, and an individual sprinkler elevation is respectively formed between the spraying directions of the outlets and the horizon reference surface of the level-meter. Accordingly, the difficult problem to improve the inconvenience of correcting its sprinkler elevation of a conventional fixed-type drain type sprinkler is solved.

### BACKGROUND OF THE INVENTION

### 1. Field of the Invention

The present invention relates to a structure of a fire fighting sprinkling head, particularly to a fire fighting sprinkler device having a leveling correcting function.

### 2. Description of Related Art

For the conventional fire fighting sprinkler devices, such as a fire fighting sprinkling head, mounted on a building, a highly pressurized fire protection water or a highly pressurized fire protection foam is spayed to the outside through its outlet so as to obtain temperature decreasing or fire extinguishing effect by means of the sprinkled fire protection water or the sprinkled fire protection foam.

Because a height or an area of the building or civil facilities are different from each other, the kinds of the mounted sprinkling heads are different. In order to match with the requirements of the fire regulation, when the height from ground to a ceiling of a location, such as a tunnel, a warehouse, etc, is large, a drain type sprinkler should be used. to swiftly distinguish the fire.

The drain type sprinkler comprises a fixed-type drain type sprinkler and a movable type drain type sprinkler. In order to use the fixed-type drain type sprinkler to spray fire protection water or fire protection foam upon a pre-determined coverage area, to correct a sprinkler elevation of the fixed-type drain type sprinkler is an important thing when the fixed-type drain type sprinkler is mounted. Conventionally, the sprinkler elevation of the fixed-type drain type sprinkler is revised by using a level-meter. However, no flat surface for mounting the level-meter as a basis surface is provided on the sprinkling head body of the fixed-type drain type sprinkler, it is not convenient to correct the sprinkler elevation of the fixed-type drain type sprinkler.

Furthermore, when the fixed-type drain type sprinkler is mounted in a tunnel, e fire in the tunnel can be distinguished swiftly to decrease the damages of the fire. It is necessary to spray fire protection water or fire protection foam upon a pre-determined coverage area by using the fixed-type drain type sprinkler. Thus, it is a technological subject to he overcome to easily correct the sprinkler elevation of the fixed-type drain type sprinkler.

### SUMMARY OF THE INVENTION

The objective of the present invention is to solve the problem of difficulty to easily correct the sprinkler elevation of the fixed-type drain type sprinkler by providing a fire fighting sprinkler device having a leveling correcting function of the present invention.

In order to achieve the objective, the technical plan of this invention is to provide a fire fighting sprinkler device having a leveling correcting function comprising:

a sprinkling head body at different locations of which a plurality of outlets having different spraying directions are disposed, the plurality of outlets being fluidly connected to each other by means of the sprinkling head body, the sprinkling head body being fluidly connected to a fire water supply pipeline by using a pipe joint, the pipe joint having at least one rotary connecting center line; and

a level-meter fixed to the sprinkling head body and having a horizon reference surface,

wherein the level-meter is disposed along a radial slit of the rotary connecting center line, and an individual sprinkler elevation is respectively formed between the spraying directions of the outlets and the horizon reference surface of the level-meter.

In one preferred embodiment of the present invention, the pipe joint is preferably a bending pipe, and a first rotary connecting center line and a second rotary connecting center line are respectively formed at two ends of the pipe joint.

According to the present invention, the pipe joint respectively preferably has a first mouth of pipe and a second mouth of pipe at its two ends, the pipe joint is fluidly connected to the sprinkling head body through the first mouth of pipe, the pipe joint is fluidly connected to the fire water supply pipeline through the second mouth of pipe, the first rotary connecting center line is formed at the first mouth of pipe and the second rotary connecting center line is formed at the second mouth of pipe.

According to the present invention, the pipe joint preferably is bending at a right angle so that the directions of the first mouth of pipe and the second mouth of pipe are perpendicular to each other.

According to the present invention, the level-meter preferably is disposed along a radial slit a the first rotary connecting renter line of the pipe joint.

According to the present invention, a flat surface preferably is formed at the sprinkling head body and the level-meter is fixed on the flat surface.

According to the present invention, the sprinkling head body preferably is disposed at a side wall of a tunnel.

According to the above techniques of this invention, after comparison with the well-know techniques of the conventional fixed-type drain type sprinkler the advantages of the present invention are that the level-meter is mounted on the sprinkling head body of the present invention in order to easily regulate the sprinkler elevation of the fixed-type drain type sprinkler, to spray fire protection water or fire protection foam upon a pre-determined coverage area by using the fixed-type drain type sprinkler and to enhance temperature decreasing and fire distinguishing effects of the fire protection water or the fire protection foam.

Other objectives, advantages, and novel features of the invention will become more apparent from the following detailed description when taken in conjunction with the accompanying drawings.

### BRIEF DESCRIPTION OF THE DRAWINGS

FIG. 1 is a three-dimensional explosive view of a first embodiment of a fire fighting sprinkler device having a leveling correcting function of the present invention.

FIG. 2 is a side view of a fire fighting sprinkler device having a leveling correcting function of FIG. 1 of the present invention.

FIG. 3 is a cross-section view of FIG. 2 of the present invention.

FIG. 4 is a movement schematic diagram of a sprinkling head body rotating about a first rotary connecting center line of the present invention.

FIG. 5 is a movement schematic diagram of the sprinkling head body rotating about a second rotary connecting center line of the present invention.

FIG. 6 is a spraying schematic diagram of the fire fighting sprinkler device having a leveling correcting function of the present invention disposed in a tunnel.

FIG. 7 is a three-dimensional explosive view of a second embodiment of a fire fighting sprinkler device having a leveling correcting function of the present invention.

### DETAILED DESCRIPTION OF THE PREFERRED EMBODIMENT

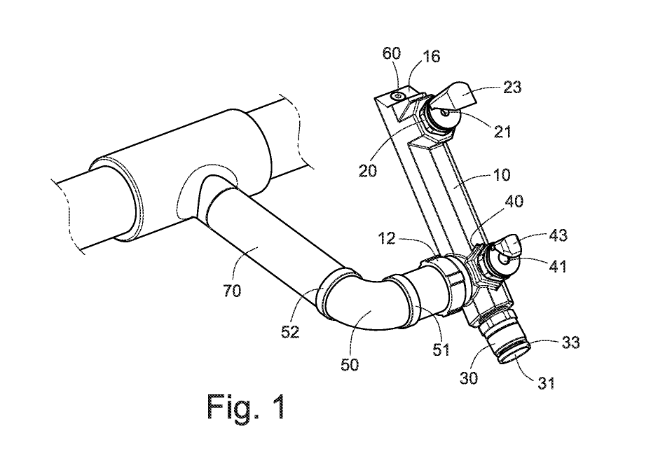

Please refer to FIGS. 1 to 3 which respectively disclose a configuration of a first preferred embodiment of the present invention demonstrating a fire fighting sprinkler device having a leveling correcting function provided in the present invention comprising a sprinkling head body 10 and a level-meter 60.

The sprinkling head body 10 is made by molding a metal material and is a tube of a circular shape or a polygon shape. A passage 11 is formed in the sprinkling head body 10. An inlet 12 for fluidly connecting to the passage 11 is formed at one side of the sprinkling head body 10. The sprinkling head body 10 is fluidly connected to the fire water supply pipeline 70 through the inlet 12 so that the water in the fire water supply pipeline 70 passes through the inlet 12 and enters into the passage 11. The term of “water” is referred to the fire protection water or the fire protection foam.

In one embodiment of the present invention, at a top of it a top layer draining interface 13 and at a bottom of it a bottom layer draining interface 14 are formed on the sprinkling head body 10. A middle layer draining interface 15 is formed between the top layer draining interface 13 and the bottom layer draining interface 14 on the sprinkling head body 10. The middle layer draining interface 15 is located near the inlet 12. The water moving in the passage 11 can pass through the top layer draining interface 13, the bottom layer draining interface 14 and the middle layer draining interface 15 to spray out. Furthermore, the top layer draining interface 13 and the middle layer draining interface 15 are respectively disposed in the radial direction of the sprinkling head body 10. The bottom layer draining interface 14 is disposed in the axial direction of the sprinkling head body 10.

A long range sprinkler head 20 made by molding a metal for guiding a spraying direction of the water in the passage 11 to spray out is fixed and assembled by a screw at the top layer draining interface 13. Furthermore, a long range outlet 21 for fluidly connecting to the passage 11 is formed at an end of the long range sprinkler head 20. A first spoiler 23 is formed and extends from the long range sprinkler head 20. In implementation, the first spoiler 23 for guiding a spraying direction of water emitted from the long range outlet 21 to spray in a long range sprinkling direction 211 extends obliquely from a lateral side of the long range outlet 21 to a front end of the long range outlet 21.

A short range sprinkler head 30 made by molding a metal for guiding a spraying direction of the water in the passage 11 to spray out is fixed and assembled by a screw at the bottom layer draining interface 14. Furthermore, a short range outlet 31 for fluidly connecting to the passage 11 is formed at an end of the short range sprinkler head 30.

short range sprinkling direction 311 is formed from the short range outlet 31 and extends along its centerline. The water in the passage 11 moves through the short range outlet 31 to spray out in the short range sprinkling direction 311.

In real implementation, a tube-shaped nozzle 33 is assembled by a screw in the short range sprinkler head 30. One end of the nozzle 33 extends to an outside of the short range sprinkler head 30. The short range outlet 31 is formed at the nozzle 33. In more details, a plurality of passing holes 331 are formed on an outer wall of the nozzle 33. A ring-shaped channel 332 is formed between the outer wall of nozzle 33 and an inner wall of the short range sprinkler head 30. When the water in the passage 11 enters into the short range sprinkler head 30, the water sprays out from the short range outlet 31 and enters into the channel 332 via the passing holes 331. Thus, the water moves through the channel 332 to spray out in an irradiating way so as to increase the coverage range during spraying from the short range sprinkler head 30.

A middle range sprinkler head 40 made by molding a metal for guiding a spraying direction of the water in the passage 11 to spray out is fixed and assembled by a screw at the middle layer draining interface 15. Furthermore, a middle range outlet 41 for fluidly connecting to the passage 11 is formed at an end of the middle range sprinkler head 40. A second spoiler 43 is formed and extends from the middle range sprinkler head 40. In implementation, the second spoiler 43 for guiding a spraying direction of water emitted. from the middle range outlet 41 to spray in a middle range sprinkling direction 411 extends obliquely from a lateral side of the middle range outlet 41 to a front end of the middle range outlet 41.

Please refer to Figs. I and 2 demonstrating the pipe joint 50 is a bending pipe. A first mouth of pipe 51 and a second mouth of pipe 52 are respectively formed at both ends of the pipe joint 50. In more details, the pipe joint 50 is bending at a right angle so that the directions of the first mouth of pipe 51 and the second mouth of pipe 52 are perpendicular to each other. Furthermore, the pipe joint 50 is fluidly connected to an inlet 12 of the sprinkling head body 10 via the first mouth of pipe 51 and is fluidly connected to the fire water supply pipeline 70 via the second mouth of pipe 52 so that the water in the fire water supply pipeline 70 flows through the pipe joint 50 and enter into the passage 11 in the sprinkling head body 10.

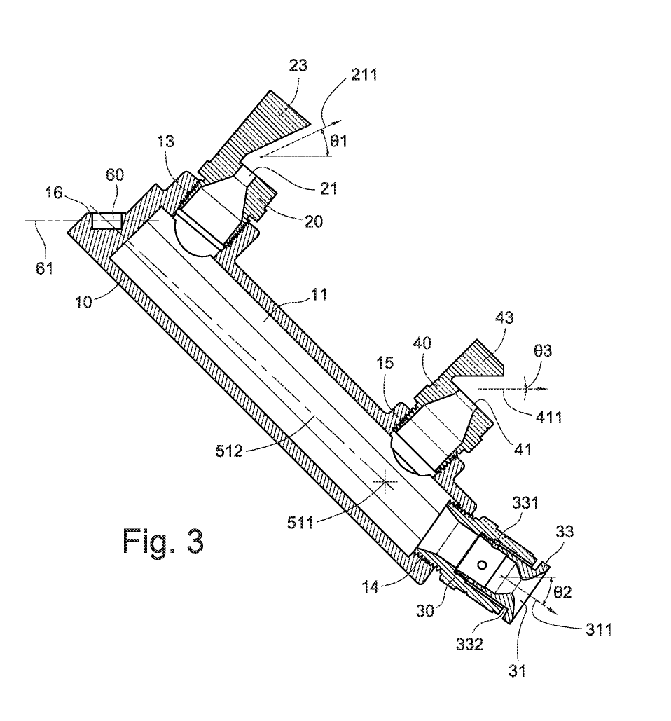

Please refer to FIGS. 1 and 3 demonstrating the level-meter 60 can be a circular bubble-type level-meter. In implementation, the level-meter 60 is secured to the sprinkling head body 10. In more details, a flat surface 16 is formed at top of the sprinkling head body 10. The level-meter 60 is fixed to the flat surface 16. Furthermore, the flat surface 16 can provide a horizon reference surface 61. When the bubble in the level-meter 60 is located in the middle of the level-meter 60, the horizon reference surface 61 of the level-meter 60 is parallel to the level line of the ground surface.

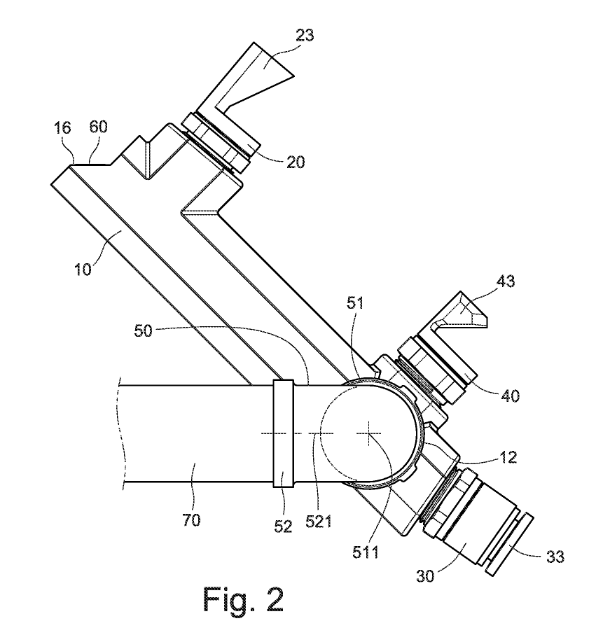

Please refer to FIGS. 2 and 3 demonstrating when the pipe joint 50 is bending at a right angle, the pipe joint 50 comprises a first rotary connecting center line 511 and a second rotary connecting center line 521 which are perpendicular to each other. The first rotary connecting center line 511 and the second rotary connecting center line 521 are respectively formed at the first mouth of pipe 51 and at the second mouth of pipe 52. In one embodiment, the first rotary connecting center line 511 is a center line of the first mouth of pipe 51 while the second rotary connecting center line 521 is a center line of the second mouth of pipe 52. Furthermore, the level-meter 60 is located at a radial slit 512 of the first rotary connecting center line 511 of the pipe joint 50.

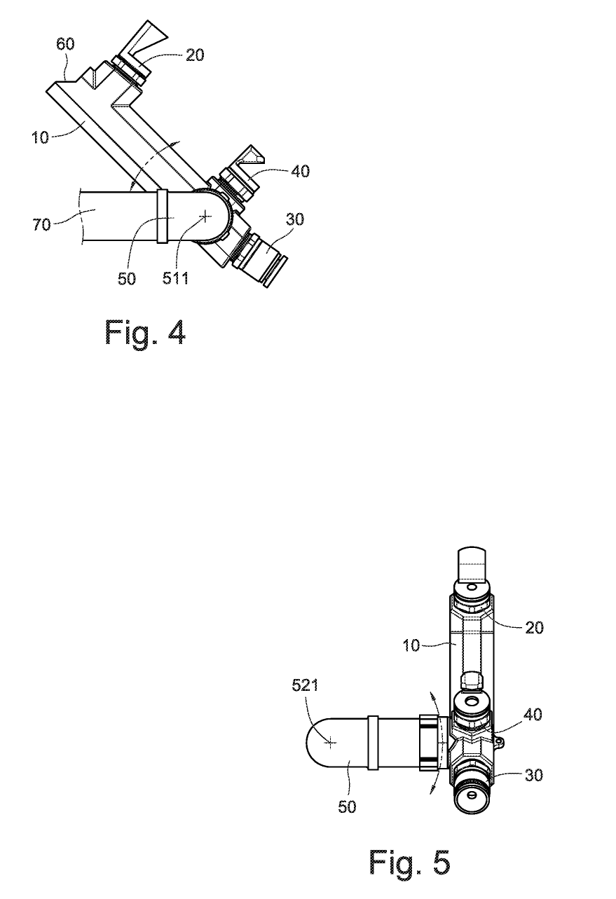

When the sprinkling head body 10 is mounted, it should be locked to connect along the first rotary connecting center line 511 as shown in FIG. 4. Because the level-meter 60 is located at the radial slit 512 of the first rotary connecting center line 511, for the level-meter 60 the sprinkling head body 10 is rotated to regulate a leveling between the horizon reference surface 61 and the level line of the ground surface.

Because the first rotary connecting center line 511 can be a radial slit of the second rotary connecting center line 521, during mounting the sprinkling head body 10 can be locked to connect along the second rotary connecting center line 521 as shown in FIG. 5 so that the level-meter 60 is slightly rotated and regulated in the radial direction of the second rotary connecting center line 521 for the sprinkling head body 10 to further regulate a leveling between the horizon reference surface 61 and the level line of the ground surface. By using a dual-axis regulating rotation along the first rotary connecting center line 511 and the second rotary connecting center line 521 of the sprinkling head body 10, the real leveling between the horizon reference surface 61 of level-meter 60 and the level line of the ground surface is accomplished so as to accurately and conveniently regulate effects of spraying direction and spraying range of the outlets on the sprinkling head body 10.

Please refer to FIG. 3 demonstrating a water elevation θ1 (25 degrees) is formed between the long range sprinkling direction 211 and the horizon reference surface 61, a water elevation θ2 (35 degrees) is formed between the short range sprinkling direction 311 and the horizon reference surface 61 and a water elevation θ3 (zero degree) is formed between the middle range sprinkling direction 411 and the horizon reference surface 61. Alternatively, when the horizon reference surface 61 is parallel to the level line of the ground surface, the water in the passage 11 moves through the long range outlet 21 and is sprayed out to a front end in an upward inclined manner in the long range sprinkling direction 211. The water in the passage 11 moves through the short range outlet 31 and is sprayed out to a front end in a downward inclined manner. The water in the passage 11 moves through the middle range outlet 41 and is sprayed out to a front end in a horizontal direction which is parallel to the level line of the ground surface.

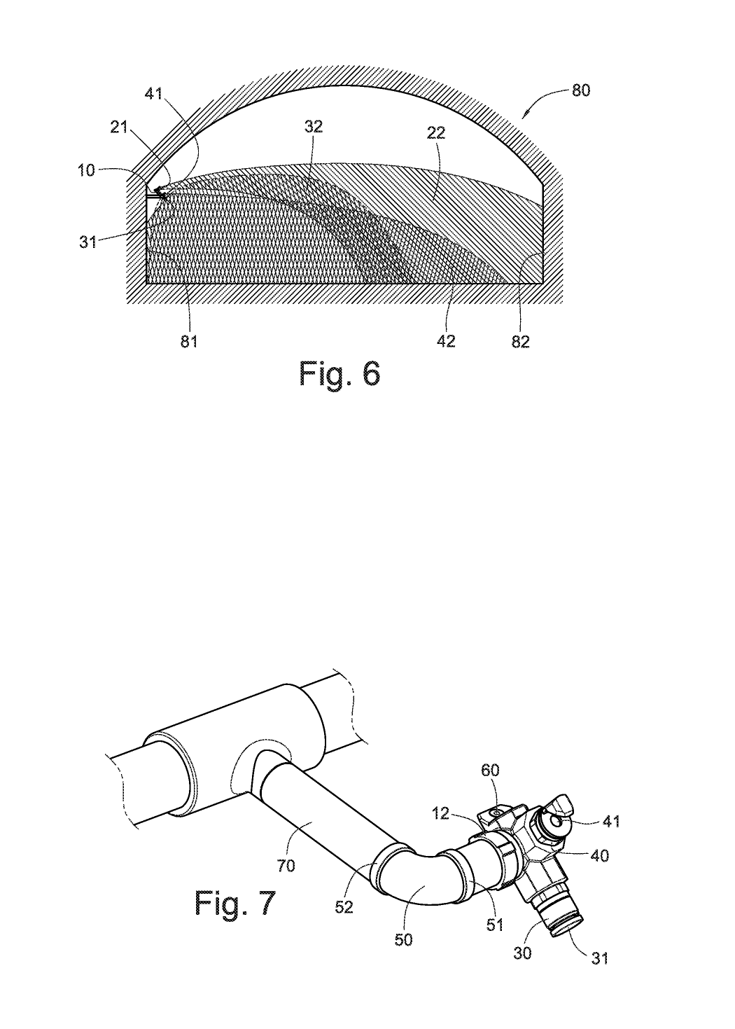

Please refer to FIG. 6 demonstrating in one embodiment the sprinkling head body 10 can be disposed on a side wall 81 in a tunnel 80. When a fire occurs in the tunnel 80, the water sprayed out from the long range outlet 21 can be sprayed on a corresponding lateral wall 82. The water sprayed out from the short range outlet 31 can be sprayed on a rear side wall 81. The water sprayed out from the middle range outlet 41 is forming a middle range sprinkling area 42 the size of which is between the long range sprinkling area 22 of the long range outlet 21 and the short range sprinkling area 32 of the short range outlet 31. By using the water sprayed out from the long range outlet 21, the short range outlet 31 and the middle range outlet 41, the whole space in the tunnel 80 can be effectively covered so as to obtain effects of swift heat absorbance and fire coverage.

Please refer to FIG. 7 demonstrating a second embodiment of the fire fighting sprinkler device of the present invention which is different from the first embodiment in that no long range sprinkler head 20 is mounted on the sprinkling head body 10. The sprinkling area of sprayed water in this embodiment is constructed by the middle range sprinkling area 42 of the middle range sprinkler head 40 and by the short range sprinkling area 32 of the short range sprinkler head 30 so that the whole space in the tunnel 80 can be effectively covered by the sprayed water.

Although the present invention has been explained in relation to its preferred embodiment, it is to be understood that any other possible modifications and variations can be made without departing from the scope of the invention as hereinafter claimed.

We claim:

1. A fire fighting sprinkler device having a leveling correcting function, comprising:
a sprinkling head body at different locations of which a plurality of outlets having different spraying directions are disposed, the plurality of outlets being fluidly connected to each other by means of the sprinkling head body, the sprinkling head body being fluidly connected to a fire water supply pipeline by using a pipe joint, the pipe joint having at least one rotary connecting center line; and
a level-meter fixed to the sprinkling head body and having a horizon reference surface,
wherein the level-meter is disposed along a radial slit of the rotary connecting center line, and an individual sprinkler elevation is respectively formed between the spraying directions of the outlets and the horizon reference surface of the level-meter.

2. The fire fighting sprinkler device having the leveling correcting function as claimed in claim 1, wherein the pipe joint is a bending pipe, and a first rotary connecting center line and a second rotary connecting center line are respectively formed at two ends of the pipe joint.

3. The fire fighting sprinkler device having the leveling correcting function as claimed in claim 2, wherein the pipe joint respectively has a first mouth of pipe and a second mouth of pipe at its two ends, the pipe joint is fluidly connected to the sprinkling head body through the first mouth of pipe, the pipe joint is fluidly connected to the fire water supply pipeline through the second mouth of pipe, the first rotary connecting center line is formed at the first mouth of pipe and the second rotary connecting center line is formed at the second mouth of pipe.

4. The fire fighting sprinkler device having the leveling correcting, function as claimed in claim 3, wherein the pipe joint is bending at a right angle so that the directions of the first mouth of pipe and the second mouth of pipe are perpendicular to each other.

5. The fire fighting sprinkler device having the leveling correcting function as claimed in claim 3, wherein the level-meter is disposed along a radial slit of the first rotary connecting center line of the pipe joint.

6. The fire fighting sprinkler device having the leveling correcting function as claimed in claim 1, wherein a flat surface is formed at the sprinkling head body and the level-meter is fixed on the flat surface.

7. The fire fighting sprinkler device having the leveling correcting function as claimed in claim 1, wherein the sprinkling head body is disposed at a side wall of a tunnel.
